(19) United States
(12) Patent Application Publication
(10) Pub. No.: US 2026/0339621 A1
(43) Pub. Date: Oct. 29, 2026

(54) No-Code Software System and Method Using a Flow-Based User Interface

(71) Applicant: Haltable Software, LLC, Spokane, WA (US)

(72) Inventor: Raymon Ohmori, Seattle, WA (US)

(73) Assignee: Haltable Software, LLC, Spokane, WA (US)

(21) Appl. No.: 19/658,875

(22) Filed: Apr. 27, 2026

Related U.S. Application Data
(60) Provisional application No. 63/795,496, filed on Apr. 27, 2025.

(51) Int. Cl. G06F 8/34; G06F 9/451

(52) U.S. Cl. CPC G06F 8/34; G06F 9/451

(57) ABSTRACT

A system and method for defining and enforcing rules governing interactions within interactive participant-driven systems using a visual flow-based interface. The system comprises a flow design interface that enables a user to arrange configurable rule-definition blocks, including action blocks, wait blocks, loop blocks, and branch blocks, in a sequential flow between a start node and a terminal node, thereby defining an ordered set of rules without requiring programming knowledge. An execution engine processes the defined rule flow during an interactive session, maintaining an internal state representation, enforcing the defined rules, and communicating state data to participant client devices operated by human users or automated agents. The system is applicable to games, training simulations, and other interactive participant-driven experiences.

### CROSS-REFERENCE TO RELATED CASES

The application claims the benefit of U.S. Provisional Patent Application Serial No. 63/795,496, filed on Apr. 27, 2025, which is hereby incorporated by reference in its entirety.

### TECHNICAL FIELD

The present disclosure relates to systems and methods for visual no-code flow-based rule definition and enforcement for interactive participant-driven systems.

### BACKGROUND

Interactive participant-driven systems allow one or more people to participate in a guided, rule-governed activity. Such activities include tabletop and card games, training simulations, educational exercises, and other interactive experiences. These types of activities share a common characteristic: participants make decisions and take actions within a structured environment, and a set of rules governs which actions are permitted, what consequences follow from those actions, and how the activity progresses. Systems that enable such activities currently fall into two groups:
Custom-built applications designed to run one specific activity or a small collection of activities, built by a team of software developers.
Generalized software which allows administrators to create their own activities by defining components, arranging them within the system using provided tools, and sharing these activities with others.

While both types of implementations have their strengths, they have notable drawbacks. A custom-built application can only run the activities it was designed for and requires an experienced team of software developers to build and maintain the software and infrastructure. Generalized software allows a non-technical user to create activities, but those activities are either unscripted, requiring participants to manually enforce rules during the activity, or use programming languages such as Lua or PHP for automation, which require significant programming knowledge from the activity designer. In addition, open-ended scripting makes external program interaction difficult and provides no formal way to reason about the rules governing the activity.

Separately, visual workflow automation tools exist that allow non-technical users to define sequences of automated operations using flow-based interfaces. However, these tools are designed for automated pipelines that execute without human intervention during runtime. They do not address the fundamentally different problem of defining enforceable rules for interactive systems in which one or more participants make real-time decisions, and in which an execution engine must continuously mediate between what participants wish to do and what the defined rules permit. There remains a need for a system that enables non-programmers to visually define rules for interactive participant-driven activities and to have those rules automatically enforced during a live session.

### SUMMARY

Described is a system and method for defining and enforcing rules governing interactions within interactive participant-driven systems. The system introduces a visual flow-based interface where activity designers can define complete rule sets without programming knowledge. A rule flow for any given activity will have a start node and a terminal node, and the designer inserts various rule-definition blocks between them to define the activity's rules. In an example embodiment, the rule-definition blocks fall into several categories: action blocks (performing single operations such as transferring elements between groups, changing the active participant, or displaying messages), loop blocks (executing a contained sequence of blocks iteratively), wait blocks (pausing execution until a participant performs an action satisfying a defined condition), branch blocks (evaluating conditions against the system state and directing execution along different paths), timer blocks (pausing execution for a specified duration), race branch blocks (executing multiple branch paths concurrently and proceeding when the first path completes), and optional scripting blocks for complex rules. Each block can be precisely configured through a configuration interface to specify exact behaviors. Although the techniques described herein have particular advantages in the development of interactive games playable by one or more participants over a network, the systems and methods have broader applicability to training simulations, educational exercises, and other interactive participant-driven experiences.

Also described is an execution engine that processes a defined rule flow to enforce the defined rules during an interactive session. The execution engine interprets the rule-definition blocks sequentially, maintaining an internal state representation and communicating state data with participant client devices, which may be operated by human users or automated agents. The execution engine transmits to each participant client device a filtered view of the internal state representation based on visibility rules, such that each participant receives only the state data that participant is permitted to observe. The internal state representation comprises a plurality of groups, each group containing zero or more elements with associated properties. The approach offers significant advantages: enabling non-programmers to create sophisticated rule-governed activities, encouraging automation that improves participant experience by managing element movement and rule enforcement, and allowing external programs, particularly generalized artificial intelligence agents, to better understand activity rules by analyzing the complete rule flow, possible actions at any given wait block, the current state, and potential future events and branch paths. The system supports both synchronous turn-based sessions and real-time sessions by determining valid participant actions based on the current internal state rather than strictly enforcing turn order.

### BRIEF DESCRIPTION OF THE DRAWINGS

FIG. 1 is a schematic view of the transfer of information between the server running the execution engine and the participant client devices, for viewing and interacting with the system.

FIG. 2 is a diagram showing the empty flow design interface and the tool selection interface with the various block options.

FIG. 3 is a flow chart showing an example of the flow design interface as configured to run the rules for a child's game, Crazy Eights.

FIG. 4 is an example configuration interface for an example atomic block, the Deal Cards block.

FIG. 5 is an example configuration interface for a wait block, configured to wait for a participant to draw or play as one would use inside the game Crazy Eights.

FIG. 6 is an example configuration interface for a branch block, showing a method of allowing greater flexibility in configuring rules for a more complex block.

FIG. 7 shows an embodiment of the execution engine, designed to process an arbitrary user-defined rule flow in a generic way.

FIGS. 8 and 9 show an example of a system interacting with the execution engine, showing the movement of pieces on a board based on a defined rule flow.

FIG. 10 shows an embodiment of a user experience for an application leveraging the execution engine as described in this application.

FIG. 11 is a diagram showing the element hierarchy used in the internal state representation, with elements categorized into groups and pieces, and their respective subtypes.

FIG. 12 is a flow chart showing an example rule flow that uses a race branch block to impose a time limit on participant actions, with a penalty action executed when the time limit expires.

### DETAILED DESCRIPTION

The embodiments described herein relate to a system and method for no-code visual flow-based rule definition and enforcement for interactive participant-driven systems. The following embodiments illustrate the invention primarily using interactive games as an example, as the techniques described herein have particular advantages in the development of interactive games playable by one or more participants over a network. However, the systems and methods described below are applicable to any interactive participant-driven system in which rules govern participant actions, including training simulations, educational exercises, and other interactive experiences, as further described herein.

In many interactive systems, certain activities and actions are allowed by participants, and other activities and actions are not allowed. The permissibility of such actions can vary during a session based on the status of one or more state variables. The present invention allows the visual definition of rules that govern available participant actions, and provides an execution engine that enforces those rules during a live interactive session. To illustrate the invention, a primary example environment of a tabletop or card game will be utilized in the following paragraphs.

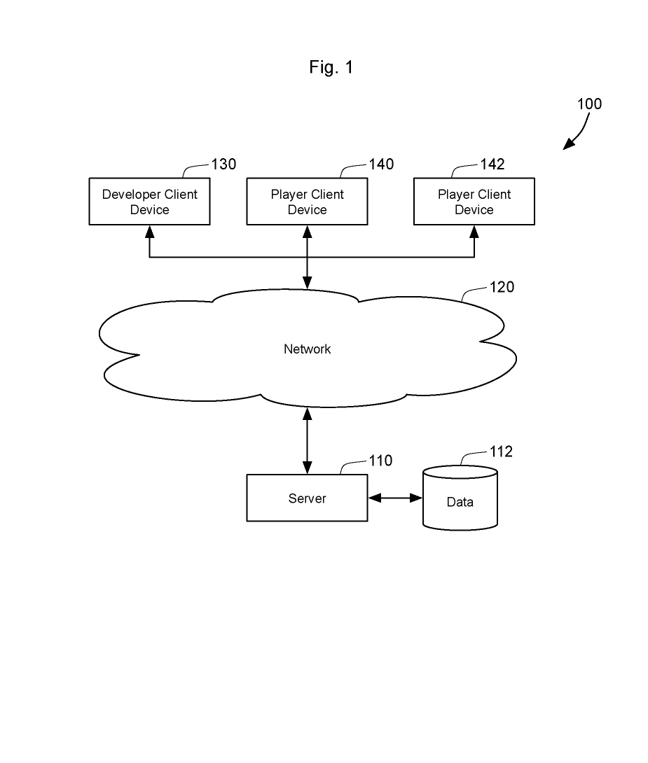

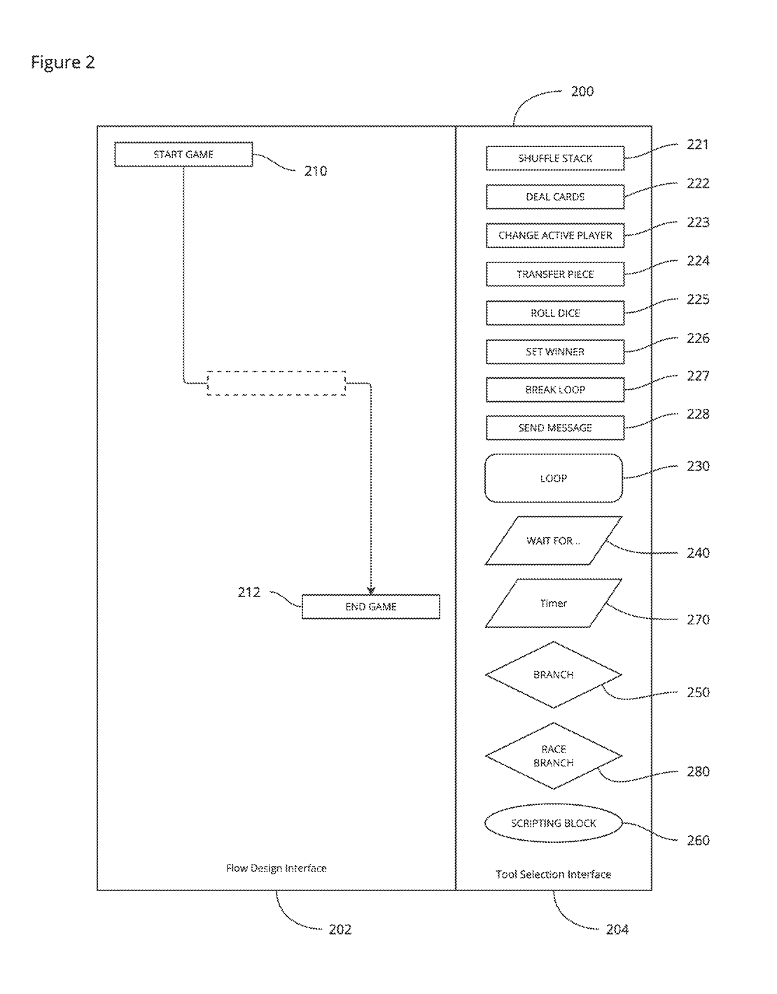

FIG. 1 shows a system 100 that can be used to implement a first embodiment of the present invention. The system uses a server 110 that communicates over a network 120 with a plurality of client devices, including the developer client device 130, and the player client devices 140, 142. The server 110 is coupled to a data store 112 for persisting rule definitions, session state, and other application data. In this game embodiment, the participant client devices 140, 142 are referred to as player client devices, and participants are referred to as players. The server 110 operates to provide a developer user interface, such as user interface 200 shown in FIG. 2, to the developer client device 130 over the network 120.

The user interface 200 allows activity designers (referred to in this game embodiment as game designers) operating the developer client device 130 to fully encompass any game's rules using a flexible rule flow structure. FIG. 2 shows an implementation of this concept. The interface allows a user to visually select a start node 210 (shown in FIG. 2 as a start game icon) and a terminal node 212 (shown as an end game icon) to define the beginning and ending point of the rule flow. In between the start node 210 and the terminal node 212, the user can visually insert rule-definition blocks to define any number of rules governing the game's interactions.

This flow could be embodied within a computer user interface that is presented to the developer client device 130, including but not limited to a cloud-based browser interface or a physical representation of the flow attached to a computing device.

The user interface 200 provides game designers with a fixed set of rule-definition blocks (referred to in this game embodiment as "blocks"); these are chained together to form the rule flow. In user interface 200 shown in FIG. 2, the user designs the rule flow in a first portion of the user interface 200 known as the flow design interface 202. A second portion, known as the block library interface 204 (shown in FIG. 2 as the tool selection interface), allows the user to make selections of rule-definition blocks for use in the flow design interface 202. The rule-definition blocks are represented visually in the user interface 200 as blocks. In one embodiment, an implementation includes, but is not limited to, the following categories of blocks:
Examples of action blocks 220 (referred to as atomic blocks), which perform a single operation, updating the internal state representation. Predefined atomic blocks may include but are not limited to elements such as shuffling stacks of cards 221, dealing cards 222, changing the active player 223, transferring cards or pieces from one location to another 224, rolling dice 225, setting a winner 226, and displaying a message to one or more participants 228.
Loop blocks 230, which contain other blocks and execute them in a repeating loop until a break condition (defined in the loop) or break event (triggered by an atomic block 227) is met.
Wait blocks 240, which pause execution of the rule flow until one or more participant(s) or agent(s) perform an action.
Branch blocks 250, which contain one or more sequences of blocks and execute different sequences of blocks based on which condition, if any, is met.
Scripting blocks 260, which, although optional, retain the flexibility of traditional scripting for complex rules.
Timer blocks 270, which pause execution for a configurable duration before continuing to the next block. Timer blocks may be used as standalone delays in the flow or within a race branch block as described below.
Race branch blocks 280, which are visually similar to branch blocks 250 but operate differently: a race branch block contains two or more branch paths that are executed concurrently, and when any one branch path completes, the remaining branch paths are cancelled and execution continues after the race branch block.

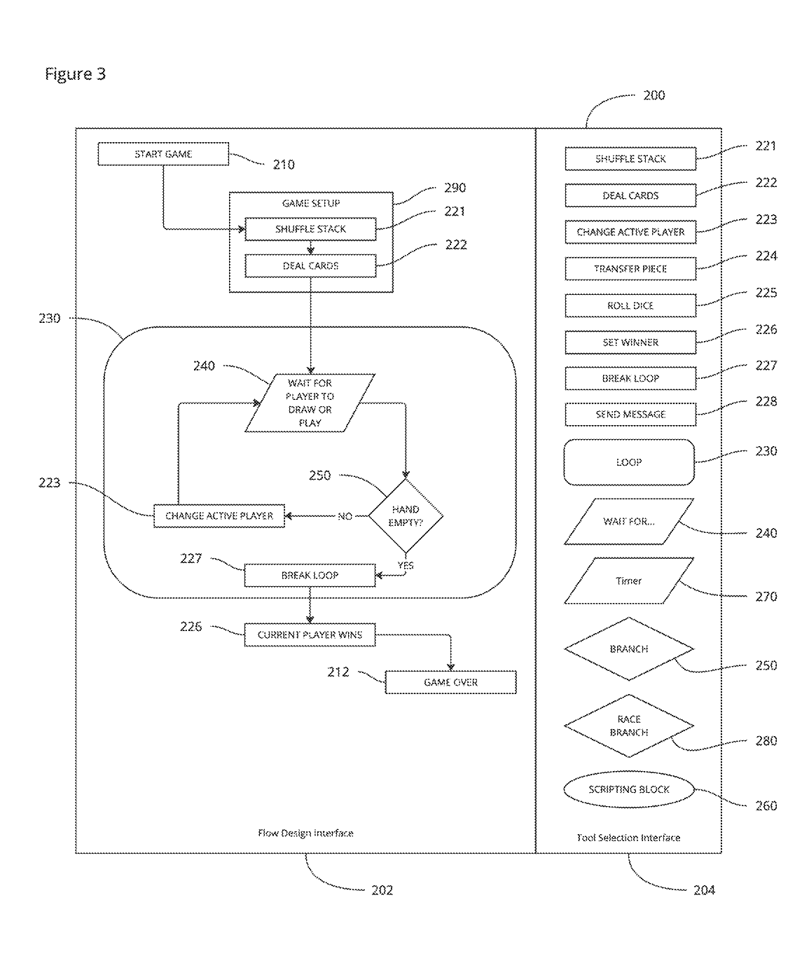

To give a concrete example of how a flow structure may be designed with the described user interface, the interface 200 may be used to define the flow for the child's card game "Crazy Eights," as shown in FIG. 3. When playing Crazy Eights, this embodiment of the flow begins with a visual grouping of elements for game setup 290, containing deck shuffling 221 and card dealing 222 atomic blocks, followed by the loop block 230. Contained within the loop, there are several blocks; the active player will either play or draw a card at the junction defined by the wait block 240, at which point the logic will check if the current player has no cards remaining in their hand with the branch block 250. If the current player's hand is not empty, the flow remains within the loop block, and the next player will become the active player with the change active player atomic block 223. If instead the current player's hand is empty, the flow exits the loop block via the atomic break loop block 227, a winner is determined with the atomic winner selection block 226 and the rule flow reaches the terminal node 212 (shown as the game over block in FIG. 3). While this is a simple example, the system can accommodate games of any complexity through a unique combination of discrete actions, events and states.

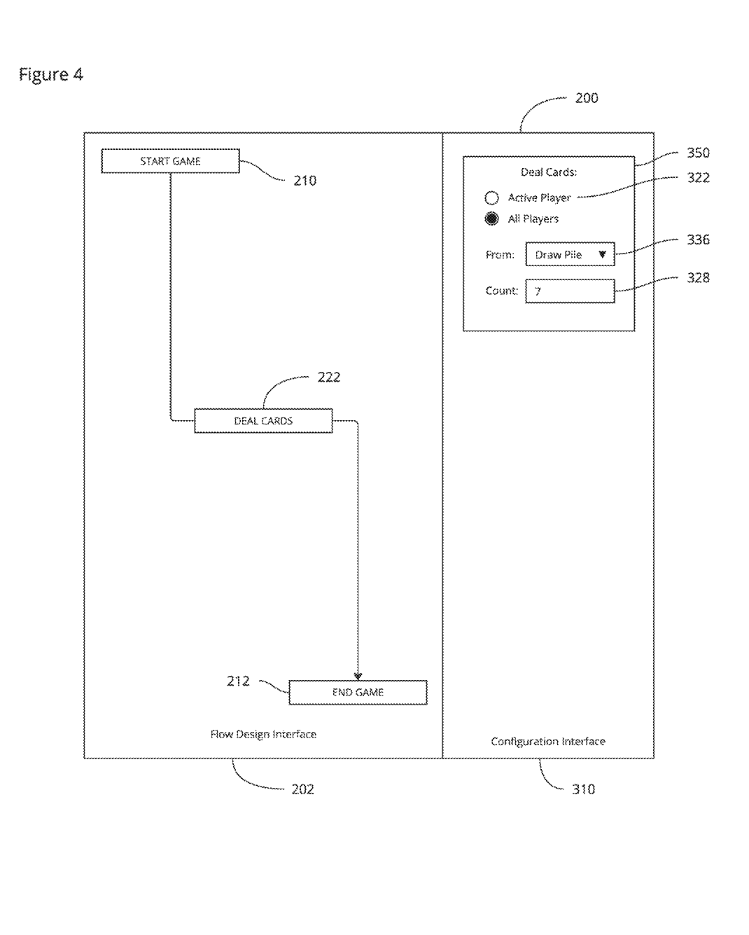

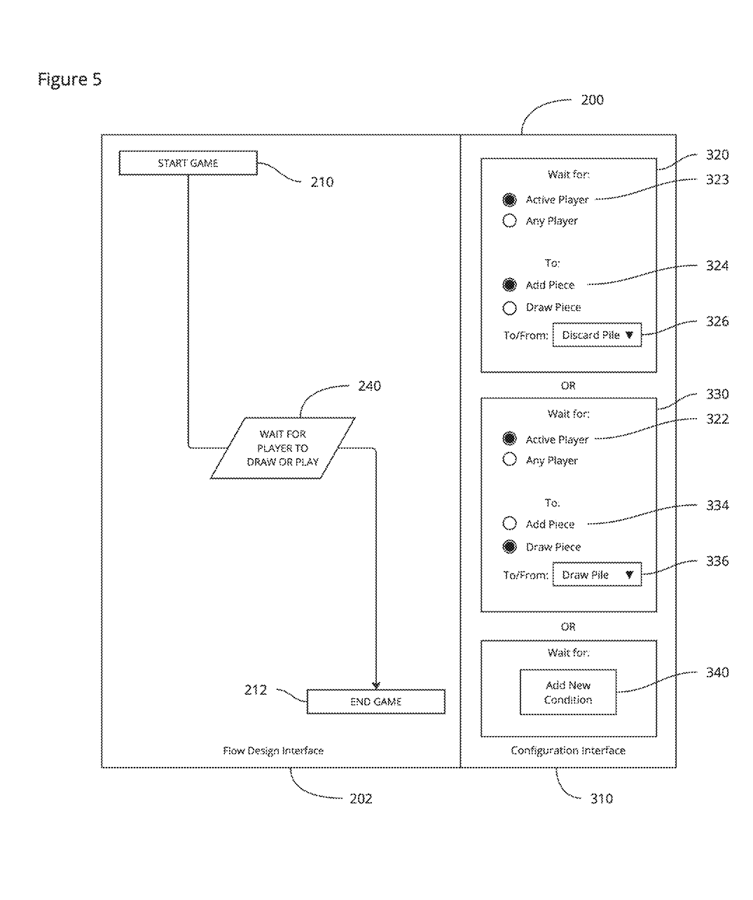

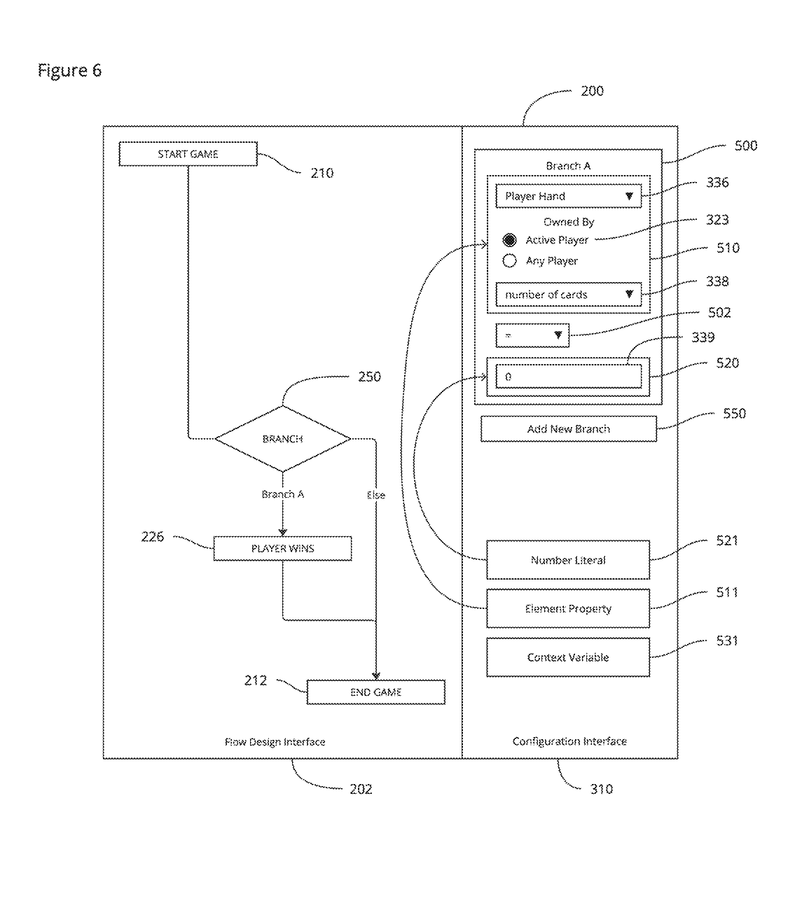

While working with pre-defined blocks is convenient, such blocks will usually need to be configured in different ways to match the flexibility of a traditional scripting engine. Following are some examples of how blocks may be configured in this particular embodiment:
An atomic block such as the deal cards block 222 may be configured with the source of which the cards to be dealt should be drawn from, and how many cards should be dealt, as game rules will vary for these factors. This may include a configuration interface as shown in FIG. 4. Upon selection of the deal cards block 222 that is used in the flow 202, a configuration interface 310 (shown as a block options configuration area) may be shown to the user. This configuration area could include a panel 350 with the options specific to that block. In this embodiment, the block is configured such that all players will get cards with input 322, the cards should come from the draw pile 336, and seven cards should be dealt with input 328.
A wait block may be configured with what event(s) to wait for. An example of this concept is shown in FIG. 5; portrayed is how a configuration might look for the wait block 240 as used in the Crazy Eights example from FIG. 3. Such a block may have been configured with two alternative wait conditions 320 and 330. Wait condition 320 is an example of a configuration where only the active player 323, adding a piece 324, to the discard pile 326, would satisfy the condition. Wait condition 330 is an example of a configuration where only the active player 323, drawing a piece 334, from the draw pile 336, would satisfy the condition. Inputs 326 and 336 are examples of inputs that may be offering select options from externally defined game designer software. Such configurations can also be used to constrain what actions the user or artificial intelligence agents may take.
A branch block 250 may be configured with the conditions that need to be met to take certain branching paths, as shown in FIG. 6. Each branch 500 may be configured with a conditional, 502, that would return a boolean value. The conditional could compare two values, shown in this example as the property of an element 510, and a number literal 520 (containing a number input 339). Both value interfaces could be dragged into the conditional equation from options in a selection palette, 511, 521 and 531, to allow for flexible conditions. In this example, the element property input 510 is configured to check the number of cards 338 in the player hand element 336 owned by a specified player, such as the active player, using input 323. Element properties may include but are not limited to values or properties such as the position, type, color, count, orientation, or owners of objects during runtime. Branch block logic may also use information from other areas of the system state, including but not limited to the history of user actions, what element was last moved, number of players, connection status of players, or time elapsed; using these types of values could be enabled in this embodiment by dragging in the Context Variable input 531. Other types of inputs could be offered depending on the implementation. Since a branch block may have a variable number of paths to next blocks, the configuration interface may include an "add more branches" function as shown with button 550. With the configuration shown in FIG. 6, the flow design interface 202 shows a flow in which Branch A, (configured with interface 500 inside 310), is only to be taken if the active player's hand is empty. Branch A leads to a "player wins" block 226 which is followed by the game ending with 212; the fallback path (taken in this example if the active player's hand is not empty) leads to the game simply ending.

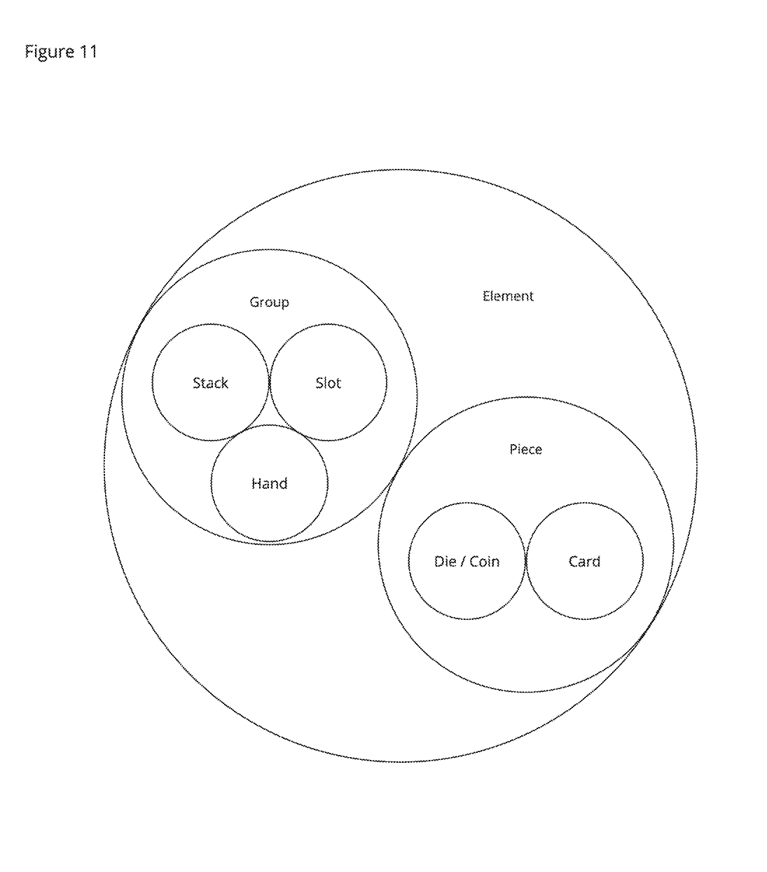

The internal state representation maintained by the system during an interactive session is organized around an element hierarchy, as shown in FIG. 11. At the base of this hierarchy is an element, which represents any discrete object or space within the interactive system. Elements are categorized into two principal branches: groups and pieces. A group is an element that can contain other elements as children. Groups are further specialized into subtypes based on how they organize their children and what containment rules they enforce. A stack is a type of group that maintains an ordered sequence of its children; stacks may contain only stackable elements such as cards, enabling implicit behaviors such as shuffling the order of elements within the stack. A slot is a type of group that holds its children in an unordered collection without tracking sequence; slots are used to represent spaces such as board positions, discard piles, or zones where the relative order of contained elements is not significant. Neither stacks nor slots contain nested groups. A hand is a type of group that can contain both elements and nested groups; hands are defined once as a template in the rule definition and are automatically cloned by the execution engine for each participant when an interactive session is initialized, so that each participant receives an independent set of groups with identical structure. This per-participant cloning ensures that all logical groups associated with a given participant are available without requiring the activity designer to manually define separate groups for each participant. A piece is an element that represents a discrete interactable object. Pieces are further specialized into subtypes that carry additional inherent behaviors. A card is a type of piece that has two distinct sides and supports a flip operation to toggle between them. A die is a type of piece that has a configurable number of sides and supports a roll operation that produces a random result from among those sides; a coin is a form of die having two sides. Other interactable objects such as tokens, tiles, and markers are represented as pieces without additional specialized behaviors. Each element in the hierarchy may have associated properties, such as position, type, color, count, orientation, or ownership. The rule-definition blocks described above operate on these elements and groups to modify the internal state representation. The

hierarchical structure with specialized subtypes enables implicit behaviors (for example, a shuffle operation applies to stacks but not to unordered slots, and a flip operation applies to cards but not to generic pieces), thereby reducing the need for custom scripting and simplifying the creation of rule definitions in the flow design interface 202.

The execution engine transmits to each participant client device a filtered view of the internal state representation, ensuring that each participant receives only the state data that participant is permitted to observe. Visibility is controlled at the group level and applies primarily to cards, which have two distinct sides. Each group that contains cards has a visibility setting selected from a set of predefined modes. For groups in a common area accessible to all participants, available visibility modes include, but are not limited to: all contained cards face down, only the topmost card face up with the remaining cards face down, or all contained cards face up. For groups within a participant's hand, the visibility setting additionally determines whether the contained cards are faced toward the owning participant (so that the owning participant and any spectators can see the card faces while other participants cannot) or faced away from the owning participant (so that other participants can see the card faces while the owning participant cannot). By embedding these visibility behaviors into the group definition, the activity designer can configure common visibility patterns without writing custom code, since the visibility behavior of cards within a given group type such as a stack or hand rarely changes during a session. When the execution engine transmits state data to a participant client device, the engine evaluates the visibility setting of each group and the facing state of each card within that group relative to the receiving participant. For any card that is face down from the perspective of the receiving participant, the execution engine strips identifying information from the card object before transmission, so that the transmitted state data does not reveal the hidden card's identity. This server-side filtering prevents unauthorized access to hidden state by participant client devices, whether operated by human users or automated agents. In other embodiments, visibility rules may be extended to apply to other element types beyond cards.

As described above, the block taxonomy includes a timer block 270 and a race branch block 280. A timer block 270 pauses execution of the rule flow for a specified duration before the execution engine advances to the next block. When used as a standalone block in the rule flow, the timer block functions as a simple delay (for example, pausing for a brief interval between automated actions to allow participants to observe state changes). The timer block may be configured through the configuration interface 310 with a duration value specifying the length of the pause. A race branch block 280 enables concurrent execution of two or more branch paths within the rule flow. When the execution engine encounters a race branch block, it begins processing the contained branch paths concurrently. Each branch path may contain any combination of rule-definition blocks, including wait blocks, timer blocks, action blocks, and other block types. When any one branch path completes (that is, when the execution engine reaches the final block in that branch path) the execution engine cancels the remaining branch paths and continues execution of the rule flow at the block following the race branch block. Any state changes made by partially-executed cancelled branch paths persist in the internal state representation; the execution engine does not roll back changes made by cancelled branches prior to cancellation. The race branch block is visually presented in the flow design interface 202 in a manner similar to the branch block 250, with parallel paths emanating from a single node, but is distinguished by the absence of conditional expressions. The paths are not selected by evaluating conditions but rather by which path completes execution first. A race branch block may be configured with two or more branch paths through the configuration interface 310. In combination, the timer block and race branch block enable time-constrained interactions. For example, an activity designer may place a wait block in

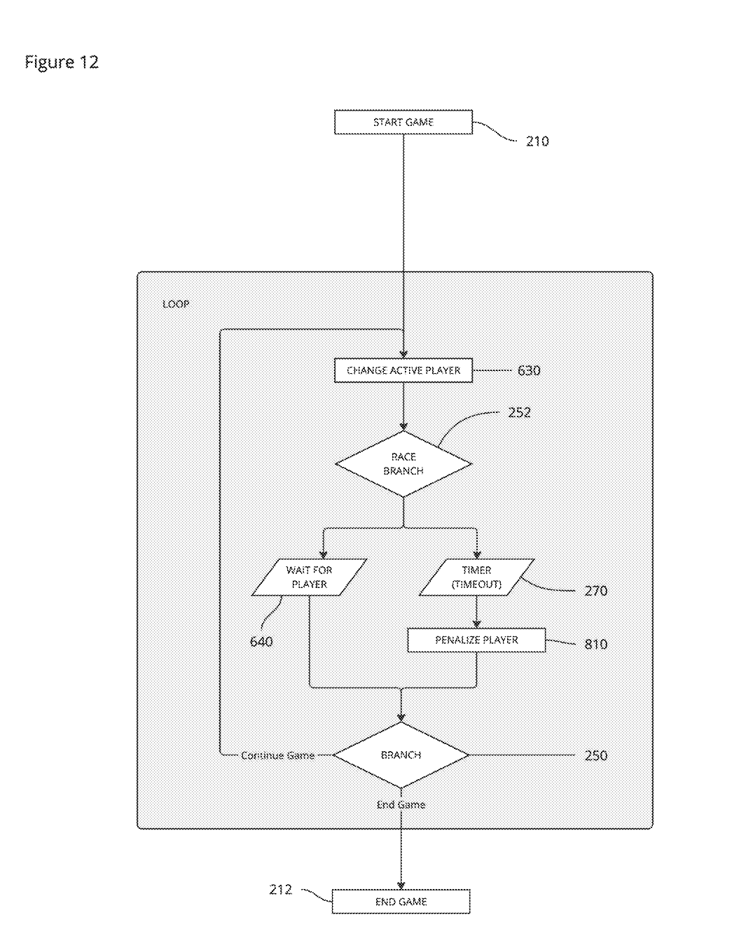

one branch path of a race branch block and a timer block in another branch path. If the participant satisfies the wait condition before the timer expires, the wait block's branch path completes first and the timer branch is cancelled; if the timer expires before the participant acts, the timer block's branch path completes first and the wait block's branch path is cancelled. This pattern allows the activity designer to impose time limits on participant actions without writing custom code. FIG. 12 illustrates a concrete example of this pattern in the context of a game with timed turns. The rule flow begins at the start node 210 and enters a loop block. Within the loop, a change active player block 630 (an instance of the change active player block 223) designates the next participant. The rule flow then enters a race branch block 252 (an instance of the race branch block 280), which splits into two concurrent paths. The first path contains a wait for player block 640 (an instance of the wait block 240), which pauses execution until the active participant performs a valid action such as playing a card. The second path contains a timer block 270 that begins counting down a specified duration; if the timer expires before the participant acts, execution continues within that path to a penalize player block 810 (an instance of an action block 220), which performs a penalty operation such as forcing the active participant to draw one or more cards from a stack. Whichever path completes first wins the race: if the participant acts in time, the wait block's path completes and the timer path is cancelled before the penalty executes; if the timer expires, the penalty is applied and the timer path completes, cancelling the wait block's path. After the race branch block 252 converges, a branch block 250 evaluates whether the game should continue or end (for example, by checking whether a win condition has been met). If the game continues, execution loops back to the change active player block 630 for the next participant's turn; if the game ends, execution proceeds to the terminal node 212.

As described above, the block taxonomy includes an optional scripting block 260. The scripting block is a type of action block that accepts user-defined program code written in a programming language, such as JavaScript, and executes that code within the context of the current session state. When the execution engine processes a scripting block, it provides the user-defined code with a set of context variables representing a scoped subset of the internal state representation. These context variables may include, but are not limited to, references to specific elements, groups, element properties, the identity of the active participant, and other session state relevant to the scripting block's position within the rule flow. The context variables are provided in a read-write manner, allowing the user-defined code to both inspect and modify the state data exposed through the context variables. The user-defined code modifies the internal state by directly mutating the context variable objects provided to it. Upon completion of the scripting block's execution, the execution engine detects any changes made to the context variables and applies those changes to the internal state representation, after which execution continues to the next block in the rule flow in the same manner as any other action block. The scripting block executes the user-defined code in a sandboxed environment that is isolated from the server runtime. The sandboxed environment restricts the user-defined code from accessing the server filesystem, network resources, or other system-level capabilities, while permitting full access to the provided context variables and standard language features. This isolation ensures that user-defined code cannot interfere with the operation of the server or other concurrent sessions. The scripting block provides a mechanism for activity designers who possess programming knowledge to implement complex rule logic that may not be expressible through the predefined block types alone. Because the scripting block operates on the same internal state representation as the predefined blocks and exposes changes through the same execution engine interface, scripting blocks can be freely intermixed with other block types in the rule flow.

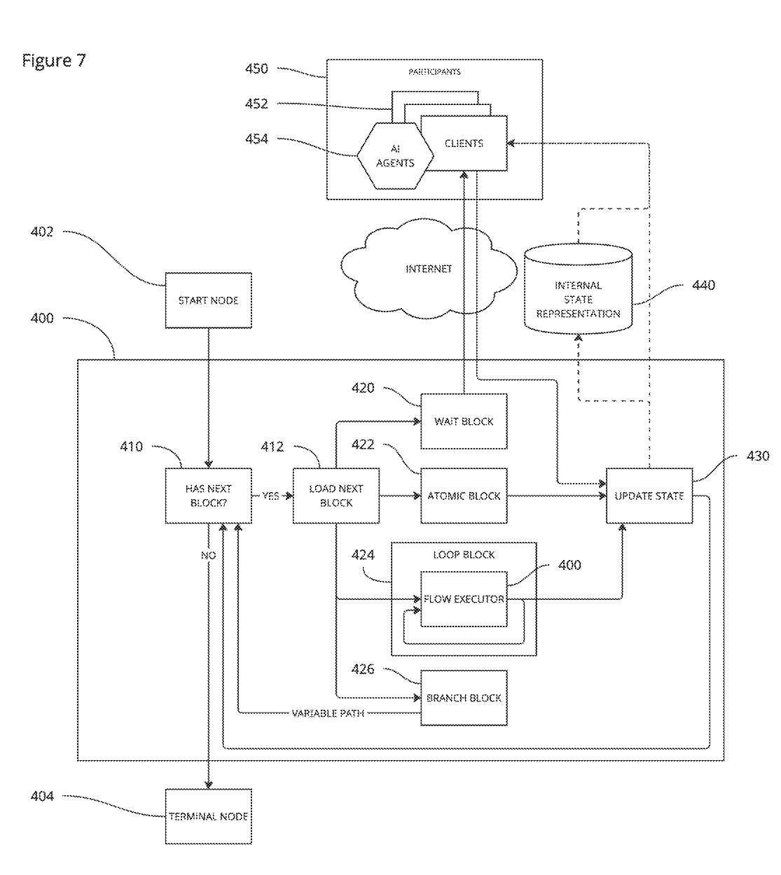

Alongside such a flow-based user interface describing the rules of a game, the server 110 will also implement an execution engine (referred to in this game embodiment as a play engine) to execute the rule flows in a deterministic fashion. In this mode, the server 110 will interact with participant client devices 140 and 142 and allow participants on those devices to play according to the defined rules. The execution engine, as shown in FIG. 7, communicates the current state to participant client devices 140 and 142 so that they can make a decision on what action to take during the interactive session. Of course, although two participant client devices (140, 142) are shown in FIG. 1, an actual interactive session may involve only one participant client device 140, or more than two participant client devices 140, 142. In other embodiments, artificial intelligence engines can control participation for one or more of the participant client devices 140, 142.

At any point during an interactive session, the execution engine (FIG. 7) can determine the current internal state representation, pending events, and possible actions. In this embodiment of the execution engine, execution starts at 402, which represents the start node 210. Execution enters a loop, 400, which first checks to see if there is a next block, at 410. If there is no next block at this stage on this or subsequent blocks, the loop will exit and end execution at 404. If there is a next block, it will become the current active block at 412, then depending on the type of block different actions will be taken:
The wait block process 420 could stop execution and wait for the configured event on the wait block 240 (configured by 310) to occur. This status may need to be communicated to participants 450 connected to the session, which may consist of user interface clients on other machines 452 and/or artificial intelligence agents 454. This allows the participant(s) to take an action that may result in the configured event for the wait block to take place. Once the event(s) occur, the execution continues to 430.
The atomic block process 422 could execute the action described by the specific atomic block, for example one of the blocks 221-227; each type of action block will adjust the internal state representation in a way specified by the embodiment's implementation. For example, shuffle stack 221 will randomize the order of cards in a stack; deal cards 222 will move cards into the player's hands. Each instance of a block inserted into the flow design interface 202 will be configured by the interface 310 with options that will be processed within 422. Once the atomic block is processed, execution will continue to 430.
The loop block process 424 could execute multiple inner blocks defined within a loop block 230 in a repeating fashion, until one of the blocks or a condition on the loop specifies to the execution engine to exit the loop. The execution engine could create a nested instance of a new execution loop 400, which would contain the blocks within the loop block 230 as defined by the flow design interface 202 (See FIG. 3, 240, 250, 223 are contained within 230). This nested execution loop would execute the blocks within the loop as described in this section, but once the final block in the loop is reached, execution starts over at the first block in the loop instead of exiting the area defined by 400. This repetitive loop would be expected to continue perpetually, and execution would never end; one way to prevent this is to introduce a break block 227; once the nested execution engine encounters this type of block the execution of this nested instance will immediately end and the original execution engine continues to 430
The branch block process 426 could check for a condition defined within the branch block 250; this block may be configured using an interface similar to 310, to check for certain conditions within the internal state representation. The conditional check would result in one of two outcomes; either the condition is met and the flow path associated with that condition would be taken, or the condition fails, and another condition will be checked. A "fallback" path option could be added to prevent the execution engine from getting stuck after all the conditions fail. The branch block process will change what "next" block will be used for the event 410, based on the condition that is met. Once the branch block process has decided which flow path will be taken, the execution engine continues to 430.

Once the execution engine reaches event 430, the internal state representation could be updated against the internal storage, notifying all connected participants 450 of the latest state, and applying any changes made by the processed block. The execution engine would then continue to 410, repeating the process for the next block. This execution engine will function in the same way for both turn-based sessions and real-time sessions (such as the card game "Speed"), since the engine's logic determines valid actions based on the current internal state representation rather than specific turns or participant interactions. With the inclusion of loop blocks, branch blocks, and scripting blocks, the execution engine supports the definition of arbitrarily complex rule flows.

The server 110 communicates with participant client devices 140, 142 via a persistent bidirectional connection, such as a WebSocket connection, over the network 120. This persistent connection allows the server 110 to push state updates to participant client devices in real time as the execution engine processes blocks and modifies the internal state representation, and allows participant client devices to transmit participant input to the server 110 when the execution engine is paused at a wait block. When the execution engine reaches event 430 (FIG. 7) and updates the internal state, the server transmits a filtered view of the updated state to each connected participant client device, as described above. When the execution engine pauses at a wait block, the server transmits to the relevant participant client devices the set of valid actions available to the participant, based on the configuration parameters of the wait block. A participant client device may then submit an action to the server, and the execution engine validates the submitted action against the wait block's conditions before resuming execution. As described above, the block taxonomy includes a message block, which is a type of action block. When the execution engine processes a message block, it transmits a notification containing designer-specified content to one or more participant client devices. The message block may be configured through the configuration interface 310 with the content of the notification and a participant scope specifying the intended recipients, such as the active participant, all participants, or a specific participant. The message block is processed as a fire-and-forget action: the execution engine transmits the notification and immediately continues to the next block in the rule flow without pausing for acknowledgment. Message blocks enable activity designers to provide feedback, instructions, or status updates to participants at specific points in the rule flow without requiring custom code. The system supports automated agent participants in addition to human participants operating browser-based client devices. An automated agent connects to the server 110 via the same persistent bidirectional connection and communication protocol used by browser-based client devices, but through a programmatic API endpoint rather than a graphical user interface. The automated agent receives the same filtered state data and set of valid actions that a human participant would receive at a given wait block, and submits actions to the server in the same format. Because automated agents and human participants use the same communication interface, an automated agent can participate in any interactive session without requiring modifications to the execution engine or the rule definition. This enables the development of generalized artificial intelligence agents that can analyze the rule flow, evaluate the current state and available actions, and participate in any activity defined with this system.

The execution engine employs several mechanisms to handle error conditions and maintain session integrity. When the execution engine encounters an error while processing a rule-definition block (for example, due to a malformed or outdated block definition) the execution engine catches the error, leaves the internal state representation unchanged, and advances to the next block in the rule flow. This fail-safe approach ensures that a single block error does not terminate the entire session or leave the internal state in an inconsistent condition. Each wait block is configured with a mandatory timeout duration specifying a maximum period for the execution engine to wait for participant input. If no participant input satisfying the wait block's conditions is received within the timeout duration, the execution engine advances past the wait block to the next block in the rule flow. This mandatory timeout ensures that the rule flow cannot stall indefinitely due to an unsatisfiable condition, a disconnected participant, or participant inactivity. When a participant disconnects from the session, the execution engine continues to honor the timeout duration of any active wait block, allowing the participant an opportunity to reconnect and submit input before the timeout expires. To manage concurrent participant interactions with elements in the internal state, the server 110 implements an element-level locking mechanism. When a participant client device initiates an interaction with an element (such as moving a piece or playing a card) the client device first sends a lock request to the server for that element. The server grants the lock to the first requesting participant and rejects subsequent lock requests from other participants for the same element until the interaction is complete and the lock is released. This locking mechanism prevents conflicting simultaneous modifications to the same element, ensuring deterministic state updates regardless of the number of concurrently acting participants.

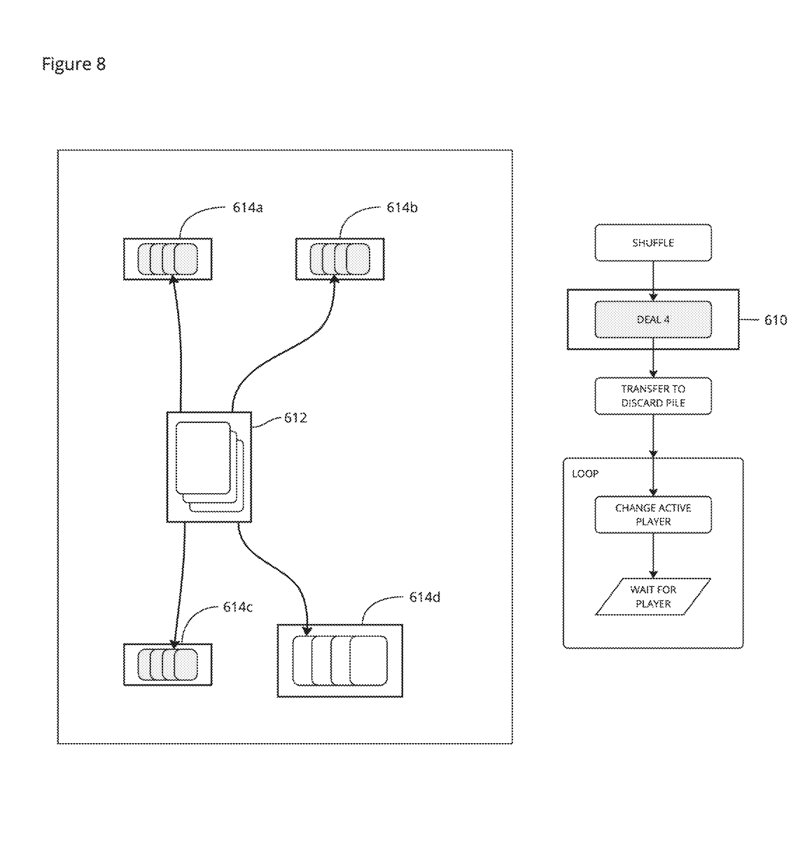

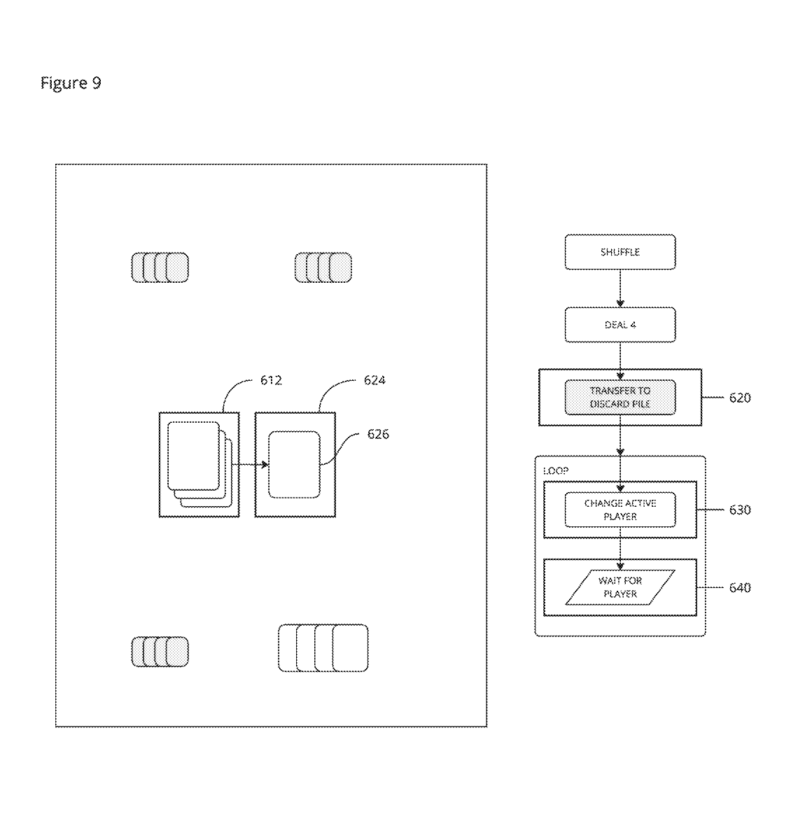

An example embodiment of the execution engine interacting with an external system at run-time is shown in FIGS. 8 and 9. As the execution engine processes the deal cards block 610 (an instance of the deal cards block 222 described with reference to FIG. 2) in FIG. 8, the cards in the stack 612 will be moved to the players' hands 614a, 614b, 614c, and 614d. In FIG. 9, the execution engine will process the transfer piece block 620 (an instance of the transfer piece block 224), which will move a card from card stack 612 to a new stack 624, the discard pile. The cards inside stack 612 and card 626 are locked and disallow user interaction using logic defined in this implementation of the game interface, until the flow reaches the wait for event block 640 (an instance of the wait block 240). When the flow reaches the wait for event block 640, the current active participant (set by the change active player block 630, an instance of the change active player block 223) is allowed to draw a card from 612 or play a card to 624, as these are the two possible event conditions defined in the wait for event block 640 (configured in the manner shown in FIG. 5).

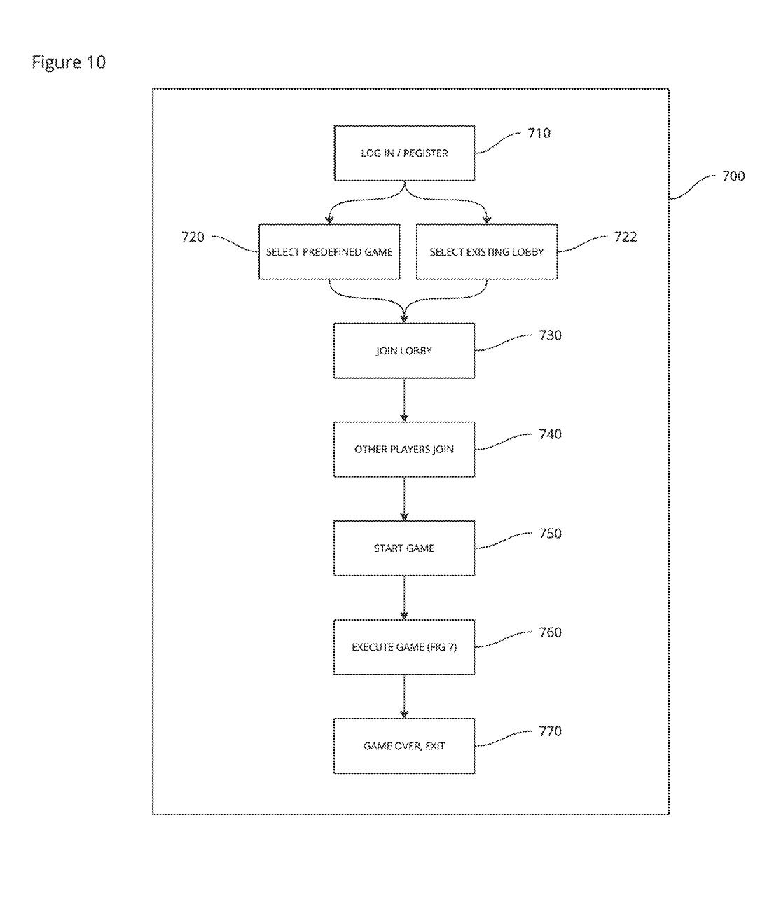

The high-level end-user flow for an embodiment of an application utilizing the execution engine as described above with reference to FIG. 7 is described in FIG. 10. The end-to-end-user experience for playing a game is encompassed in the flow 700. First, the user will log in or register at 710. Then, they may have the option to either create a new game lobby (a virtual space where players can gather before playing the game) based on an existing game and rule flow definition 720, or they may join an existing lobby that is already attached to a game and rule flow definition 722. The user interface could then guide the user to join the lobby, 730, and wait for other players to join 740. Once players have gathered in the lobby and are ready to play, the game may be started by consensus or a designated user in the lobby, 750. At this point the execution engine as described above with reference to FIG. 7 will be used to execute (run) the game 760, and control the game as described. Once the terminal node 404 is reached, the user interface will display that status to the participant in 770. The participant may then exit the application or start a new session with 720 or 722.

Although the foregoing embodiments illustrate the invention in the context of tabletop and card games, the systems and methods described herein are applicable to other interactive participant-driven systems. The following paragraphs describe additional example embodiments.

In a training or educational exercise embodiment, the system may be used to define rules for a guided learning activity in which a single participant interacts with the system. For example, an activity designer could define a rule flow for a categorization exercise in which the participant is presented with a series of objects and must sort them into correct categories. The rule flow would begin with an action block that initializes the exercise by placing objects into a presentation group. A loop block would iterate through the objects, and for each object, a wait block would pause execution until the participant places the object into one of several category groups. A branch block would then evaluate whether the participant's placement is correct by checking the properties of the placed object against the properties expected by the destination group. If correct, the flow would continue to the next object via the loop; if incorrect, a message block could display feedback to the participant before allowing another attempt. A set-winner block or equivalent action block could record the participant's score upon completion. The execution engine would enforce the rules of the exercise in the same manner as described above with reference to FIG. 7, maintaining an internal state representation of the objects and groups, and transmitting filtered state data to the participant's client device.

In an escape-room or interactive puzzle embodiment, the system may be used to define rules for a puzzle-solving activity involving one or more participants. An activity designer could define a rule flow in which participants must discover and interact with elements in a specific sequence to progress through a series of challenges. The rule flow could include wait blocks configured to pause execution until a participant performs a specific action, such as transferring an element to a designated group representing a lock mechanism. Branch blocks could evaluate whether the correct combination of elements has been assembled, directing the flow to a success path that reveals new elements or to a failure path that provides a hint via a message block. To impose time limits, the activity designer could use a race branch block containing a wait block in one branch path and a timer block in another; if the participant solves the puzzle before the timer expires, the wait block's branch path completes and the timer is cancelled, but if the timer expires first, the timer block's branch path completes and the wait block is cancelled, allowing the flow to proceed to a timeout path. Loop blocks could allow repeated attempts at a given puzzle until the participant succeeds or is moved forward by a timer expiration. The execution engine would manage the state of all elements and groups, enforce the puzzle rules, and transmit appropriate state data to each participant's client device, with visibility rules ensuring that hidden elements remain concealed until the rules permit their reveal.

The flow-based rule definition and execution engine described herein facilitates the creation of rule-governed interactive activities and enables improved artificial intelligence interaction through better rule comprehension. The system supports the development of generalized artificial intelligence agents capable of participating in any activity defined with this system without requiring activity-specific training implementations. The system offers several advantages: (1) Activity designers without programming knowledge can create and reason about rules through the visual flow interface, which can be organized into discrete sections or folders for clarity; (2) The tight coupling between the rule definition interface and the execution engine encourages designers to implement automation, improving participant experience by managing element movement and rule enforcement; (3) External programs, particularly generalized artificial intelligence agents, can better understand arbitrary activity rules by analyzing the complete rule flow, possible actions for a given wait block, the current internal state, and potential future events and branch paths. This allows an artificial intelligence program to participate in any activity defined with this system, not just specific activities it was trained for.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A system for defining rules governing interactions within an interactive participant-driven system, the system comprising:
a) a processor;
b) a non-transitory computer-readable memory coupled to the processor;
c) a display device;
d) a flow design interface rendered on the display device, the flow design interface presenting a visual canvas configured to display a start node and a terminal node defining a beginning and an end of a rule flow;
e) a block library interface rendered on the display device, the block library interface presenting a plurality of selectable rule-definition blocks, each rule-definition block representing a discrete operational unit, wherein the plurality of rule-definition blocks comprises at least:
i) an action block configured to define an operation that modifies an internal state of the interactive participant-driven system when executed,
ii) a wait block configured to pause execution of the rule flow until a participant performs an action satisfying at least one defined condition,
iii) a loop block configured to iteratively execute a contained sequence of one or more rule-definition blocks, and
iv) a branch block configured to evaluate a condition against the internal state and direct execution along one of a plurality of paths based on the evaluation;
f) a configuration interface rendered on the display device in response to selection of a rule-definition block placed on the visual canvas, the configuration interface presenting one or more input fields for setting parameters governing the behavior of the selected rule-definition block; and
g) wherein the flow design interface is configured to receive user input arranging selected rule-definition blocks in a sequential flow on the visual canvas between the start node and the terminal node, thereby defining an ordered set of rules for the interactive participant-driven system.

2. The system of claim 1, wherein the plurality of rule-definition blocks further comprises a scripting block, the scripting block being a type of action block configured to accept user-defined program code written in a programming language and to execute the user-defined program code with access to context variables representing the internal state of the interactive participant-driven system.

3. The system of claim 1, wherein the action block comprises at least one of: a transfer block configured to move one or more elements from a source group to a destination group, a change-active-participant block configured to change a designation of which participant is an active participant, or a message block configured to display a notification to one or more participants.

4. The system of claim 1, wherein the configuration interface for the wait block presents at least: a participant-scope selector for specifying whether the wait block waits for an action from a designated active participant or from any participant, an action-type selector for specifying a type of a participant action to wait for, and a group selector for specifying a group to which the participant action relates.

5. The system of claim 1, wherein the configuration interface for the branch block comprises a visual expression builder, the visual expression builder presenting a conditional expression with selectable operand positions and a selection palette offering draggable operand inputs comprising at least an element property input, a literal value input, and a context variable input.

6. The system of claim 1, wherein the flow design interface is further configured to display a visual grouping element that organizes a subset of arranged rule-definition blocks into a labeled group presented as a visually distinct unit on the visual canvas.

7. The system of claim 1, wherein the branch block is configurable with a plurality of named conditional paths, each named conditional path associated with an independently configurable condition, and a default path executed when no condition of the named conditional paths is satisfied.

8. The system of claim 1, wherein the plurality of rule-definition blocks further comprises: a timer block configured to pause execution of the rule flow for a specified duration; and a race branch block configured to define two or more contained branch paths for concurrent execution, wherein when any one contained branch path completes execution, the remaining contained branch paths are cancelled and execution of the rule flow continues after the race branch block, and wherein any state changes made by a cancelled branch path prior to cancellation persist in the internal state.

9. The system of claim 1, wherein the action block further comprises at least one of: a shuffle block configured to randomize an ordering of elements within a group, a deal block configured to distribute elements from a first group to one or more participant-associated groups, a roll-dice block configured to generate a random numerical result, or a set-winner block configured to designate a participant as a winner.

10. A system for enforcing rules during an interactive session, the system comprising:
a) a processor;
b) a non-transitory computer-readable memory coupled to the processor, the memory storing an internal state representation of the interactive session;
c) a rule definition stored in the memory, the rule definition comprising an ordered sequence of rule-definition blocks arranged in a rule flow, each rule-definition block having an associated block type and associated configuration parameters;
d) an execution engine executed by the processor and configured to:
i) sequentially process each rule-definition block in the rule flow beginning from a start node,
(1) for each rule-definition block, determine the associated block type and execute an operation corresponding to the determined block type against the internal state representation,
(2) when a processed rule-definition block is a wait block, pause execution of the rule flow until a participant provides input satisfying at least one condition defined by the configuration parameters of the wait block,
(3) update the internal state representation based on the executed operation,
ii) transmit state data derived from the internal state representation to one or more participant client devices communicatively coupled to the system, and
iii) terminate the interactive session when the rule flow reaches a terminal node.

11. The system of claim 10, wherein the execution engine is further configured to, when processing a rule-definition block having a loop block type, instantiate a nested execution cycle that iteratively processes rule-definition blocks contained within the rule-definition block having the loop block type, and to terminate the nested execution cycle upon encountering a break block within the contained rule-definition blocks or upon satisfaction of a termination condition defined in the configuration parameters of the rule-definition block having the loop block type.

12. The system of claim 10, wherein the execution engine is further configured to, when processing a rule-definition block having a branch block type, evaluate one or more conditional expressions against the internal state representation and direct execution to a path associated with a first satisfied condition, or to a default path when no condition is satisfied.

13. The system of claim 10, wherein transmitting state data comprises transmitting, to each participant client device, a filtered view of the internal state representation, the filtered view determined based on visibility rules associated with elements or groups within the internal state representation such that each participant receives only state data that the participant is permitted to observe.

14. The system of claim 10, wherein the internal state representation comprises a plurality of groups, each group containing zero or more elements with associated properties, and wherein the rule-definition blocks operate on the elements and groups to modify the internal state representation.

15. The system of claim 10, wherein the execution engine is further configured to support one or more automated agent participants that receive state data and provide input via a programmatic interface.

16. A method for enforcing rules during an interactive session of a participant-driven system, the method comprising:
a) loading, into a memory of a computing device, a rule definition comprising an ordered sequence of rule-definition blocks arranged in a rule flow;
b) initializing an internal state representation of the interactive session in the memory;
c) sequentially processing each rule-definition block in the rule flow by:
i) determining an associated block type of a current rule-definition block,
ii) executing an operation corresponding to the determined block type against the internal state representation,
iii) when the determined block type is a wait block type, pausing execution of the rule flow, transmitting state data to one or more participant client devices, and resuming execution upon receiving a participant input satisfying at least one condition defined by configuration parameters of the current rule-definition block,
iv) updating the internal state representation based on the executed operation, and
d) transmitting updated state data to the one or more participant client devices; and
e) terminating the interactive session upon reaching a terminal node of the rule flow.

17. The method of claim 16, wherein the interactive session is a game session, wherein one or more participants of the interactive session are players, and wherein the internal state representation comprises game pieces distributed across a plurality of defined groups.

18. The method of claim 16, wherein the method supports both synchronous turn-based sessions and real-time sessions, and wherein when the determined block type is a wait block type, valid participant actions are determined based on the internal state representation and the configuration parameters of the current rule-definition block.

19. The method of claim 16, wherein the rule definition comprises a plurality of rule-definition blocks arranged in a directed flow between a start node and a terminal node, each rule-definition block corresponding to a discrete operational unit selected from a set comprising at least an action block, a wait block, a loop block, and a branch block, and each rule-definition block having associated configuration parameters that govern execution behavior of the rule-definition block during the interactive session.

20. The method of claim 19, wherein the rule definition is generated based on user input received via a graphical user interface that enables selection of the plurality of rule-definition blocks and specification of the associated configuration parameters, such that the rule definition represents a user-defined set of rules governing participant interactions.
